(19) United States
(12) Patent Application Publication
(10) Pub. No.: US 2014/0144241 A1
(43) Pub. Date: May 29, 2014

(54) AUTOMATIC INCIDENCE ANGLE ADJUSTMENT FOR ULTRASOUND TEST HEADS WHICH IS DEPENDENT ON THE POSITION OF THE TEST HEADS

(71) Applicants: Michael Clossen-von Lanken Schulz, Issum (DE); Stefan Obermayr, Mulheim (DE)

(72) Inventors: Michael Clossen-von Lanken Schulz, Issum (DE); Stefan Obermayr, Mulheim (DE)

(21) Appl. No.: 13/881,014

(22) PCT Filed: Oct. 12, 2011
(86) PCT No.: PCT/EP11/67805

§ 371 Date: Jun. 4, 2013

(30) Foreign Application Priority Data
Oct. 28, 2010 (EP) 10189177.8

(51) Int. Cl. G01H 1/10

(52) U.S. Cl. CPC G01H 1/10
USPC 73/660

(57) ABSTRACT

An apparatus for ultrasound testing of a component includes an ultrasound test head and a guide unit. The guide unit is configured in such a manner that the test head is continuously moved in at least one translation direction, wherein an incidence angle of the test head with respect to a surface of the component is continuously changed at the same time.

### CROSS REFERENCE TO RELATED APPLICATIONS

This application is the US National Stage of International Application No. PCT/EP2011/067805 filed Oct. 12, 2011, and claims benefit thereof, the entire content of which is hereby incorporated by reference. The International Application claims priority to European Application No. 10189177.8 EP filed Oct. 28, 2010, the entire content of which is hereby incorporated by reference.

### FIELD OF INVENTION

The present invention relates to an apparatus for ultrasonic testing of a component, and to use of such an apparatus. The invention further relates to a method for ultrasonic testing of a component.

### BACKGROUND OF INVENTION

Components are subjected to ultrasonic testing in the course of numerous technical applications in order to assess the quality of the components or their wear or their operational loads. For example, steam turbine blades are tested in the installed state for cracks in the inaccessible blade root.

Document GB 2 195 022 A describes an ultrasonic measuring device which comprises two transducers that can be moved linearly relative to one another horizontally. Furthermore, the transducers comprise joints which are prestressed with the aid of springs and enable a correct application of the transducers to the respective surface.

Document EP 2 096 433 A1 describes an apparatus for nondestructive material testing of a test object with the aid of ultrasonic waves, the test head being attached so as to swivel on a slide. In this case, the swivel axis extends, for example, parallel to the movement direction of the slide. That is to say, the test head can move along a rail and is swivelable perpendicular thereto.

Document GB 2 015 740 A describes an apparatus for guiding ultrasonic test heads. In this case, the apparatus enables a movement and setting of the test head in two horizontal directions and, independently thereof, a partial swiveling about two horizontal axes which run parallel to the respective horizontal translation directions.

Document U.S. Pat. No. 6,247,367 B1 discloses an ultrasonic measuring arrangement in which the insonification angle can be varied with reference to a particular focal point of a surface to be examined.

Document GB 1 203 854 A describes an apparatus for examining material with the aid of ultrasound. In this case, the insonification angles of the transducers being used can be fixedly set with the aid of a mounting device.

Document U.S. Pat. No. 3,593,570 describes an ultrasonic test unit in which the ultrasonic sensor can be rotated about a rotation axis. The ultrasonic test unit can be guided over a surface to be examined.

During ultrasonic testing of complex geometries, for example the blade roots of the blade aerofoil, it is possible only with difficulty to conduct unchanging, vertical insonification onto the fault expectancy zone in conjunction with unchanging sound paths. When the surface on which the test head runs is curved entirely differently to the test surface, it is occasionally necessary for the test head position and the insonification or squint angle of the test head to be continuously varied independently of one another along the test track.

To date, it has been necessary to conduct tests with high losses in sensitivity and a greatly restricted test area, or shaped parts have been built which implemented all possible insonification positions and squint angles over discrete test head positions. However, this rendered it necessary to rebuild the test head from one position to the next, and was therefore associated with substantial time outlay. In addition, the areas between the discrete positions were not tested with equally high sensitivity.

### SUMMARY OF INVENTION

It is a first object to provide an improved apparatus for ultrasonic testing of a component. A second object is to provide the use of the improved apparatus for ultrasonic testing. A third object is to provide an advantageous method for ultrasonic testing of a surface of a component.

The first object is achieved by an apparatus for ultrasonic testing of a component, the second object is achieved by the use and the third object is achieved by a method for ultrasonic testing as claimed in the independent claims. The dependent claims include further embodiments.

The inventive apparatus for ultrasonic testing of a component comprises at least one ultrasonic test head and a guide unit. The component comprises a surface. The guide unit is configured such that the test head can be moved continuously in at least one translation direction. The guide unit is configured in this case such that the insonification angle, also known as the squint angle, of the test head simultaneously continuously varies with reference to the surface of the component. In particular, the guide unit can be configured such that during the continuous movement in at least one translation direction there is simultaneously a continuous variation in the squint angle of the test head in accordance with the perpendicular of its sound beam to that surface of the component which is to be tested.

In conjunction with the present invention, the insonification or squint angle, with reference to a surface, is the angle between the surface normal of the surface and the direction of propagation of the sound beam.

The guide unit can preferably be configured such that the test head can be moved continuously in the translation direction along the surface of the component. The guide unit advantageously comprises at least one guide rail on which the test head can be moved along continuously. In particular, the guide unit can comprise at least one guide slide on which the test head can be fastened, or is fastened. The guide unit can advantageously be configured such that the test head can be guided along on the guide rail with the aid of the guide slide.

For example, the guide unit can comprise a cage inside which the test head and/or the guide slide can be moved.

A specific squint angle is prescribed with reference to the guide unit for each test head position with the aid of the inventive apparatus. It is thereby possible to adjust both the test head position and the respective squint angle of the ultrasonic test head in a path-dependent fashion while it is being guided along a track. This renders the testing of complex components, in particular complex components of gas or steam turbines such as, for example, steam turbine blades, much simpler and substantially quicker than has been possible to date.

The guide unit can, for example, comprise a first guide element and a second guide element. By way of example, the position of the test head can be fixed with the aid of the first guide element. By way of example, the squint angle of the test head can be fixed with the aid of the second guide element.

The guide unit can advantageously comprise at least one curved guide rail and/or at least one curved guide element. The curved guide element or the curved guide rail can, for example, be of convex configuration with reference to the test surface.

The previously described inventive apparatus is used according to the invention for ultrasonic measurement on a turbine component. Such an inventive use is distinguished, for example, in that the turbine component is a steam turbine component, for example a steam turbine blade, or a steam turbine blade root.

Within the scope of the inventive method for ultrasonic testing of a component, an ultrasonic test head is moved continuously in at least one translation direction. Simultaneously, the insonification angle or squint angle of the test head is varied continuously with reference to the surface of the component. The ultrasonic test head can advantageously be moved along the surface of the component in the translation direction.

By way of example, during the continuous movement in the translation direction it is possible at the same time for the squint angle of the test head to be varied continuously in accordance with the perpendicular of its sound beam onto that surface of the component to be tested.

In particular, the squint angle can be varied by rotating the test head about an axis perpendicular to the translation direction. In principle, the guide slide can be used to guide the test head along on at least one guide rail. For this purpose, the test head can be fastened on the guide slide.

The inventive use and the inventive method basically have the same advantages as the inventive apparatus for ultrasonic testing.

Further advantages, features and properties of the present invention are described in more detail below with the aid of an exemplary embodiment and with reference to the attached figures.

### BRIEF DESCRIPTION OF THE DRAWINGS

In the figures:

FIG. 1 is a schematic of a part of a steam turbine blade with an apparatus for ultrasonic testing in accordance with the prior art, in perspective view.

FIG. 2 is a schematic of a part of a steam turbine blade with an inventive apparatus for ultrasonic testing, in perspective view.

### DETAILED DESCRIPTION OF INVENTION

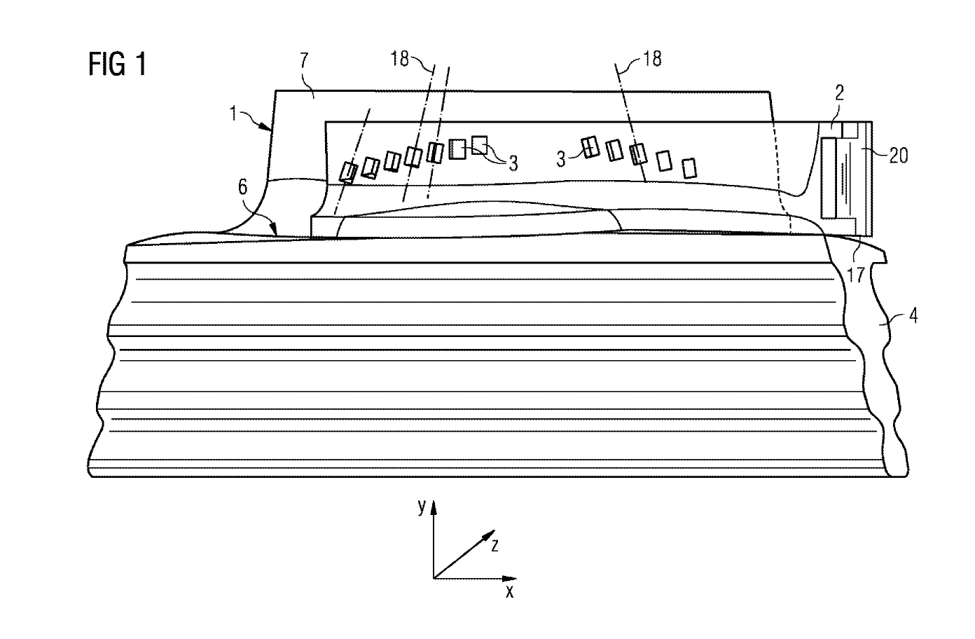

FIG. 1 is a schematic of a part of a steam turbine blade 1. The steam turbine blade 1 comprises a blade aerofoil 7 and a blade root 4. The blade aerofoil 7 adjoins the blade root 4. The surface of the turbine blade 1 which is to be tested in FIG. 1 is denoted by the reference numeral 6.

An apparatus for ultrasonic testing 2 is laid on to the component with its underside 17. The apparatus for ultrasonic testing 2 comprises a number of cutouts 3 into which an ultrasonic test head can respectively be inserted. The cutouts 3 differ in this case from one another with respect to their position in the x-direction. Furthermore, each cutout 3 comprises a longitudinal axis 18 as illustrated in FIG. 1 for some cutouts 3 merely by way of example. In addition to their position in the x-direction, the cutouts 3 are also different from one another with respect to the alignment of their respective longitudinal axis 18 with reference to the surface 6 to be tested, and/or with reference to the underside 17 of the apparatus 2. The longitudinal axis 18 of the respective cutout 3 determines the squint angle of the ultrasonic test head respectively inserted in the cutout.

The apparatus for ultrasonic testing 2 shown in FIG. 1 can be used to obtain only discrete test head positions with respect to the insonification position in the x-direction and the insonification angle or squint angle.

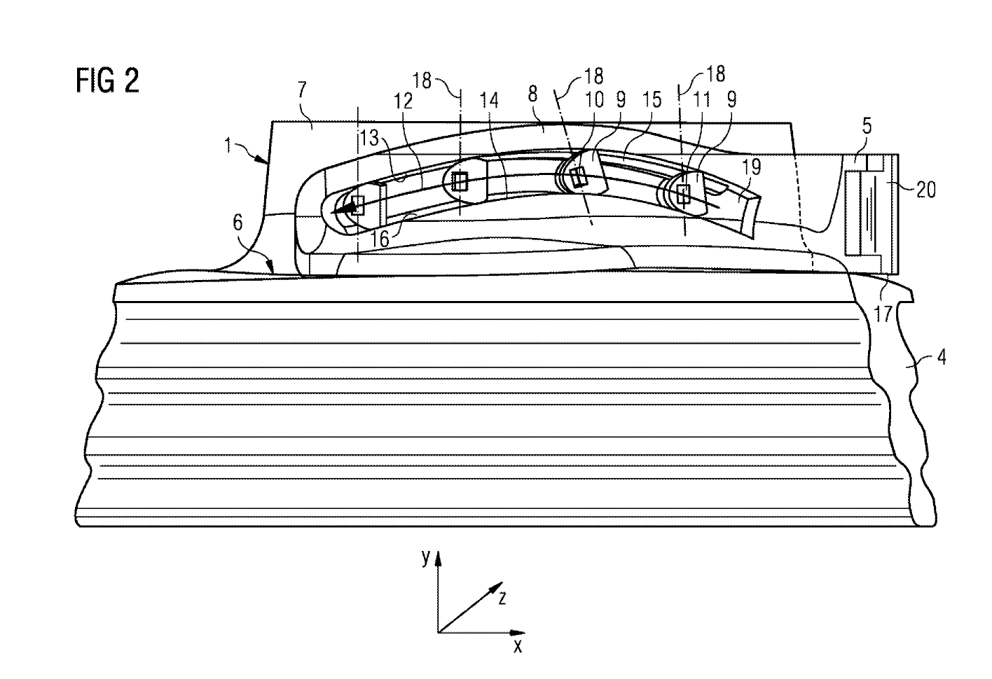

FIG. 2 is a schematic, partially in perspective, of a part of a steam turbine blade 1 with an inventive apparatus for ultrasonic testing 5. The inventive apparatus for ultrasonic testing 5 comprises an underside 17 which is laid onto a surface 6 that is to be tested of a steam turbine blade 1.

The inventive apparatus for ultrasonic testing 5 comprises a guide unit 8 and a guide handle 20. The shaped part can be positioned with the aid of the guide handle 20.

The guide unit 8 comprises an opening 19. The opening 19 is bounded by an upper guide rail 13 and a lower guide rail 14. The upper guide rail 13 comprises a guide element 15. The lower guide rail 14 comprises a guide element 16. A guide slide 9 is arranged inside the opening 19. The guide slide 9 is configured such that it can be moved within the opening 19 along the guide rails 13 and 14. The movement direction or translation direction is denoted in FIG. 2 by reference numeral 12.

In FIG. 2, the guide rails 13 and 14 and the opening 19 are of curved configuration with reference to the underside 17, in particular configured to curve convexly outward with reference to the surface to be tested or the test surface 6. The effect of this configuration is that when moving in the x-direction the guide slide 9 is also moved at the same time in the y-direction with reference to the coordinate system indicated in FIG. 2. As an alternative to this, a flat configuration of the opening 19 and/or of the guide rails 13 and 14 is also possible. In this case, the guide slide 9 would be able to move only in the x-direction.

The guide slide 9 comprises a cutout 10 for an ultrasonic test head 11. An ultrasonic test head 11 can be inserted into the cutout 10. The cutout 10 comprises an axis 18 which corresponds to a defined orientation of the test head 11. The position of the ultrasonic test head 11, and thus the test head position and the squint angle of the ultrasonic test head 11 with reference to the test surface 6 are therefore fixed by the position of the guide slide 9 with reference to the test surface 6.

The guide element 15 of the upper guide rail 13, and the guide element 16 of the lower guide rail 14 are configured in a fashion adapted to the respective test surface 6 such that in the course of the translation movement 12 the guide slide 9 rotates at least partially about an axis perpendicular to the respective translation direction 12. In FIG. 2, during the movement in the x-direction and/or in the y-direction the guide slide 9 rotates about the z-axis. In this case, there is simultaneous variation in the direction of the longitudinal axis 18, and thus in the insonification angle or squint angle, with reference to the test surface 6.

In FIG. 2, the guide slide 9 is configured as a cage in which the test head 11 is located. The guide slide 9 or cage is guided via two independent tracks 13 and 14 deformed in three dimensions along the test surface 6. The lower guide rail or track 14 in this case defines the position of the test head 11 on the surface 6. The upper track or guide rail 13 has somewhat larger cutouts and defines the squint angle of the test head 11 by a difference in position relative to the first track or first guide rail 14. The guide elements 15 and 16 engage in corresponding cutouts on the guide slide 9 or cage, and produce the respective squint angle. The guide element 15 follows the guide element 16 in the movement direction 12, and can therefore twist (cause squinting of) the entire guide slide 9 or cage.

By correct arrangement of two three-dimensionally arranged tracks or guide rails 13 and 14, it is possible to use the present invention to adjust both the test head position and the squint angle of an ultrasonic test head 11 along a track in a fashion dependent on the path. Consequently, the testing of complex components such as, for example, the testing of steam turbine blade roots is rendered much simpler, more sensitive and substantially quicker than has been possible to date.

1.-15. (canceled)

16. An apparatus for ultrasonic testing of a component, the apparatus comprising:
an ultrasonic test head and a guide unit,
wherein the guide unit is configured such that the ultrasonic test head is moveable continuously in at least one translation direction, a squint angle of the ultrasonic test head simultaneously continuously varying with reference to a surface of a component.

17. The apparatus for ultrasonic testing as claimed in claim 16, wherein the guide unit is configured such that the squint angle of the ultrasonic test head is adjusted in a path-dependent fashion while being guided along a track.

18. The apparatus for ultrasonic testing as claimed in claim 16, wherein the guide unit comprises a guide rail on which the ultrasonic test head is moveable along continuously.

19. The apparatus for ultrasonic testing as claimed in claim 18, wherein the guide unit comprises a guide slide on which the test head is fastened.

20. The apparatus for ultrasonic testing as claimed in claim 19, wherein the guide unit is configured such that the ultrasonic test head is guided along on the guide rail with the aid of the guide slide.

21. The apparatus for ultrasonic testing as claimed in claim 19, wherein the guide unit comprises a cage inside which the ultrasonic test head and/or the guide slide is moved.

22. The apparatus for ultrasonic testing as claimed in claim 16, wherein the guide unit comprises a first guide element for fixing a position of the ultrasonic test head and a second guide element for fixing the squint angle of the ultrasonic test head.

23. The apparatus for ultrasonic testing as claimed in claim 16, wherein the guide unit comprises a curved guide rail and/or a curved guide element.

24. Use of an apparatus for ultrasonic testing as claimed in claim 16 for ultrasonic measurement of a turbine component.

25. The use of an apparatus for ultrasonic testing as claimed in claim 24, wherein the turbine component is a steam turbine component.

26. The use of an apparatus for ultrasonic testing as claimed in claim 25, wherein the turbine component is a steam turbine blade.

27. A method of ultrasonic testing of a component, comprising:
continuously moving an ultrasonic test head in at least one translation direction,
simultaneously varying a squint angle of the ultrasonic test head continuously with reference to a surface of a component.

28. The method as claimed in claim 27, wherein the squint angle is varied such that the ultrasonic test head is rotated about an axis perpendicular to the translation direction.

29. The method as claimed in claim 27, wherein the ultrasonic test head is guided along on at least one guide rail with the aid of a guide slide.

30. The method as claimed in claim 27, wherein the squint angle of the ultrasonic test head is adjusted in a path-dependent fashion while being guided along a track.
